(19) United States
(12) Patent Application Publication
(10) Pub. No.: US 2008/0245716 A1
(43) Pub. Date: Oct. 9, 2008

(54) Separation column and liquid chromatography system with this column

(76) Inventors: Takeshi Ohura, Hitachinaka (JP); Tomohiro Shoji, Hitachinaka (JP); Daizo Tokinaga, Hachioji (JP); Tomonari Morioka, Hitachinaka (JP); Yoshihiro Nagaoka, Ishioka (JP); Yoshitaka Kodama, Hitachinaka (JP)

Correspondence Address: MCDERMOTT WILL & EMERY LLP, 600 13TH STREET, N.W., WASHINGTON, DC, 20005-3096, US

(21) Appl. No.: 12/076,754

(22) Filed: Mar. 21, 2008

(30) Foreign Application Priority Data
Mar. 23, 2007 (JP) 2007-076756

(51) Int. Cl. B01D 15/08

(52) U.S. Cl. 210/198.2

(57) ABSTRACT

A monolithic separation column and a liquid chromatography system using the same are provided by which the pressure tightness is improved, and the manufacturing is enabled at a low temperature, thus preventing the degradation of the separation performance. A monolithic rod 118 is made of a porous body and has a cylindrical shape. A coat material 116 coats an outer circumference of the monolithic rod 118 and includes an uneven portion 116R on an outer face thereof A holder 112, into which the monolithic rod 118 coated with the coat material 116 is inserted, includes a taper portion 112T on an inner face thereof. A potting media 114 is fitted or filled between the coat material 116 and the holder 112.

### BACKGROUND OF THE INVENTION

1. Field of the Invention

The present invention relates to a separation column used for a high performance liquid chromatography that separates a liquid sample into respective components and a liquid chromatography system using the same. More particularly the present invention relates to a separation column that uses a monolithic silica column and a liquid chromatography system using the same.

2. Background Art

Conventionally, high performance liquid chromatography has used a monolithic column with an integrated structure of a three-dimensional network-like skeleton and a void (channel, macropore, and throughpore), instead of a particle-potting column generally used, thus enabling a column with an increase in surface area but not increase in flow resistance because of a large porosity. For instance, a higher performance monolithic silica column has been achieved with a porous body (monolithic rod, monolithic silica rod) incorporated in a capillary.

Meanwhile, it is difficult to form an outer diameter, a bend and the like of the porous body precisely, and therefore a gap tends to be generated between a capillary and the porous body. To prevent the leakage of a mobile phase from a side face of the column, it is known that a resin coat material is provided on an outer circumferential face of the porous body (e.g., see JP Patent Publication (Kokai) No. 11-64314 A (1999)).

Further, in order to improve the contact between a column main body and a monolithic absorbent, it is known that monolithic molding is introduced into a fiber-reinforced plastic tube, followed by the heating of the tube.

### SUMMARY OF THE INVENTION

In the case where the resin coat material is provided on the outer circumferential face of the porous body, however, the porous body is held by a holder using an adhesion force between the materials, and therefore there is a limitation in that materials having properties of adhering well with each other have to be selected. Further, the column has a configuration not suitable for high pressure. As a result of the examination by the inventors of the present invention, favorable separation performance could be obtained only under a low-pressure condition of several MPa or lower.

Further, when the fiber-reinforced plastic tube is heated after the introduction of the monolithic molding using the tube, the porous body is at a high temperature. If a monolithic absorbent includes a silica gel support filled with filler obtained by chemical bonding of octadecylsilyl ligands, the octadecylsilyl ligands, for example, may drop off, which may cause the degradation in the separation performance of the column. Moreover, the influences of the heating are significant at the peripheral portion, and therefore the possibility of degrading the column separation performance increases as the porous body becomes thinner.

It is an object of the invention to improve the pressure tightness of a monolithic separation column and a liquid chromatography system using the same and to provide a separation column and a liquid chromatography system using the same enabling the manufacturing at a low temperature, thus preventing the degradation of the separation performance.

(1) In order to fulfill the above-stated object, a separation column of the present invention includes a cylindrical monolithic rod made of a porous body, the separation column separating a sample and a mobile phase flowing into the monolithic rod. The separation column includes: a coat material coating an outer circumference of the monolithic rod and including an uneven portion on an outer face thereof; a holder into which the monolithic rod coated with the coat material is inserted, the holder including a narrow portion or an uneven portion on at least a part of an inner face thereof along an inflow direction; and a potting media fitted or filled between the coat material and the holder.

With this configuration, a separation column with improved pressure tightness can be provided, which also enables the manufacturing at a low temperature, thus preventing the degradation of the separation performance.

(2) In the above (1), preferably, the uneven portion on the face of the coat material is formed by sandpaper or by sandblasting.

(3) In the above (1), preferably, the coat material includes a heat shrinkable tube or resin coating, the potting media includes silicon rubber or an adhesive, and the holder includes metal or resin.

(4) In the above (1), preferably, the uneven portion on the inner face of the holder includes a thread portion or a groove portion.

(5) In the above (1), preferably, the narrow portion on the inner face of the holder has a tapered shape.

(6) In order to fulfill the above-stated object, a liquid chromatography system of the present invention includes: a pump sucking a mobile phase; an autosampler sucking a sample; a separation column held in a thermo-controlled bath, into which the mobile phase sucked by the pump and the sample sucked by the autosampler are supplied to be separated into a respective component; and a detector detecting the respective component separated by the separation column. The separation column includes a cylindrical monolithic rod made of a porous body and separating a sample and a mobile phase flowing into the monolithic rod, and the separation column further includes: a coat material coating an outer circumference of the monolithic rod and including an uneven portion on an outer face thereof; a holder into which the monolithic rod coated with the coat material is inserted, the holder including a narrow portion or an uneven portion on at least a part of an inner face thereof along an inflow direction; and a potting media fitted or filled between the coat material and the holder.

With this configuration, a liquid chromatography system with improved pressure tightness can be provided, which also enables the manufacturing at a low temperature, thus preventing the degradation of the separation performance.

### EFFECTS OF THE INVENTION

In accordance with the invention, a separation column and a liquid chromatography system with improved pressure tightness can be provided, which also enables the manufacturing at a low temperature, thus preventing the degradation of the separation performance.

### BRIEF DESCRIPTION OF THE DRAWINGS

FIG. 1 illustrates the system configuration of a liquid chromatography system using a separation column according to Embodiment 1 of the present invention.

FIG. 2 is a cross-sectional view illustrating the configuration of a separation column according to Embodiment 1 of the present invention.

FIG. 3 is a cross-sectional view illustrating the configuration of a separation column according to Embodiment 2 of the present invention.

FIG. 4 is a cross-sectional view illustrating the configuration of a separation column according to Embodiment 3 of the present invention.

FIG. 5 is a cross-sectional view illustrating the configuration of a separation column according to Embodiment 4 of the present invention.

FIG. 6 is a cross-sectional view illustrating the configuration of a separation column according to Embodiment 5 of the present invention.

### DESCRIPTION OF A PREFERRED EMBODIMENT OF THE INVENTION

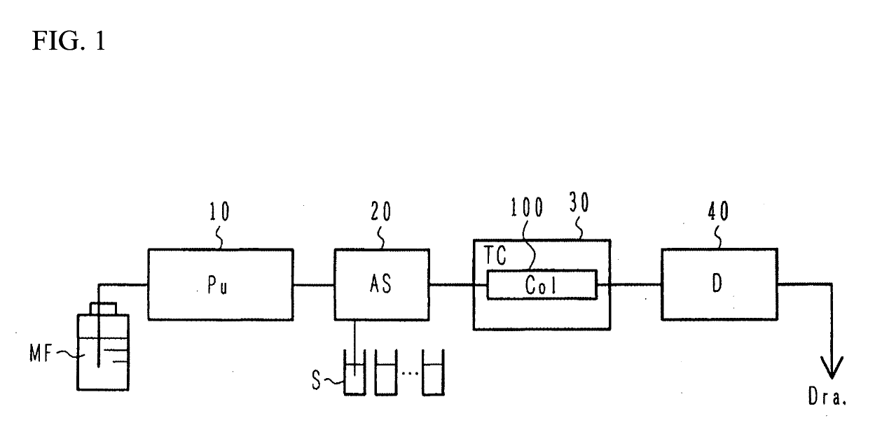

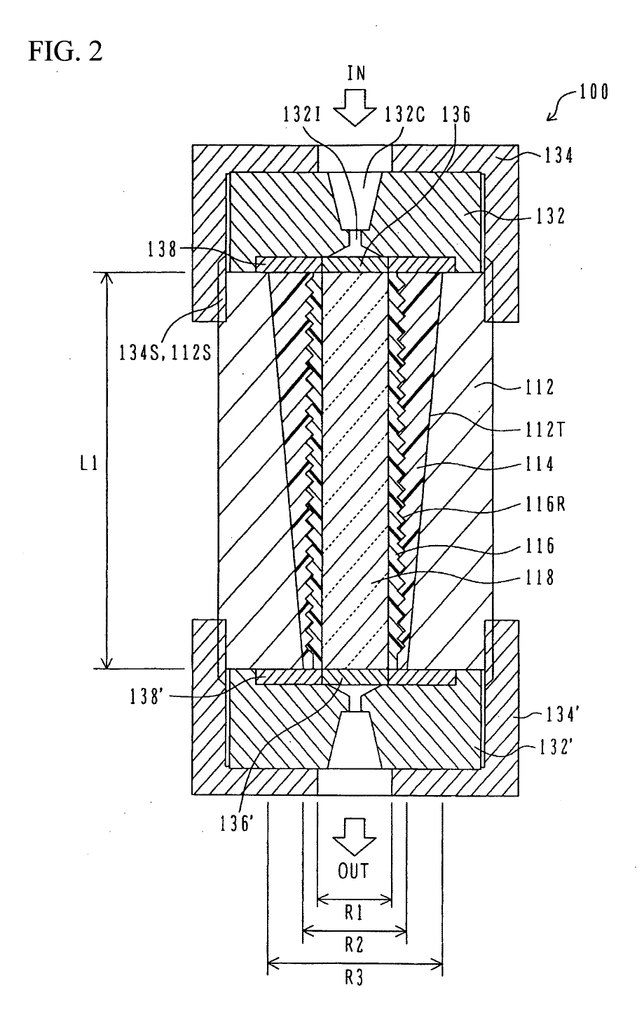

In the following, the configuration of a separation column and a liquid chromatography system using the same according to Embodiment 1 of the present invention will be described with reference to FIGS. 1 and 2.

Firstly, the configuration of the liquid chromatography system using a separation column according to the present embodiment will be described with reference to FIG. 1. In the following description, a high performance liquid chromatography system is exemplified.

FIG. 1 illustrates the system configuration of the liquid chromatography system using the separation column according to Embodiment 1 of the present invention.

The liquid chromatography system includes a pump (Pu) 10, an autosampler (AS) 20, a separation column 100 held inside a thermo-controlled bath (TC) 30, and a detector 40.

A mobile phase MF as liquid is sent to the separation column 100 by the pump 10. The separation column 100 is placed inside the thermo-controlled bath 30. The autosampler 20 is placed between the pump 10 and the separation column 100. The autosampler 20 includes a change valve within it, which absorbs a sample S and introduces the same into a channel extending from the pump 10 to the separation column 100. The introduced sample is transferred with the mobile phase sent by the pump 10 to the separation column 100, and is separated into a respective component. The respective component separated by the separation column 100 is detected by the detector 40. The mobile phase and the sample that have passed through the detector 40 are discharged to the outside as drainage Dra.

Next, the configuration of the separation column 100 according to the present embodiment will be described below with reference to FIG. 2.

FIG. 2 is a cross-sectional view illustrating the configuration of the separation column according to Embodiment 1 of the present invention.

The separation column 100 of FIG. 2 includes a cylindrical separation column unit in the center thereof, an upstream connection unit on the upstream side; and a downstream connection unit on the downstream side. FIG. 2 illustrates the state where the separation column has been assembled.

The separation column unit in the center of the separation column 100 includes a holder 112, a potting media 114, a coat material 116, and a monolithic rod (monolithic silica rod) 118, which are arranged concentrically in this order from the outer circumferential side.

The monolithic rod (monolithic silica rod) 118 is made of a porous material and is shaped like a pillar. In order to provide a liquid chromatography system operable at the maximum pressure of the mobile phase flowing into the separation column as much as 5 to 30 MPa or higher and capable of reducing the analysis time, the diameter of the monolithic rod 118 may be 1.2 to 2.8 mm, desirably 2 mm or thinner, and the length in the flowing direction, i.e., the length of the separation column 100 may be 30 mm to 200 mm, which may vary among samples to be analyzed. Thus the monolithic rod 118 may have the diameter R1 of 2 mm and the length L1 of 30, 50, 75, and 100 mm as one example.

When liquid is sent at a certain pressure, the amount of the liquid sent per unit time, i.e., the consumption amount of the mobile phase will be inversely proportional to the cross-sectional area of the monolithic rod 118, assuming that a cross-sectional area where the liquid passes through, i.e., the porosity is constant. Therefore, the use of the monolithic rod of 2 mm or thinner in diameter can lead to a decrease of the consumption amount of the mobile phase to one quarter of that using the monolithic rod of about 4 mm in diameter. Thus, an easy-to-use column can be obtained practically operable at a flow-rate range of 1.0 ml/min or lower, which is widely used for a general-purpose high-performance liquid chromatography system.

The circumference of the monolithic rod 118 is coated with the coat material 116. As the coat material 116, a heat shrinkable tube may be used with an inner diameter larger than an outer diameter of the monolithic rod 118 at a room temperature but becoming smaller by the application of heat. The heat shrinkable tube used may be made of silicone or a fluorine resin that is highly resistant to chemical agents. Alternatively, the circumference may be coated with a resin material with fluidity, a glass coating, a metal evaporation, or the like.

Since the monolithic rod 118 has asperities from about several micro meters to several tens micro meters on the outer circumferential face to be in contact with the coat material 116, a suitable material for the coat material 116 may have elasticity or fluidity that can absorb the asperities for contact therewith. Further, since liquid flows through the monolithic rod 118 at a high pressure, it is desirable that the coat material 116 is made thin so as not to generate a gap due to the deformation, or is made of a material having a large elastic coefficient.

The holder 112 is cylindrical and is made of stainless steel.

The potting media 114 is fitted or filled in a gap between the coat material 116 and the holder 112, while the monolithic rod 118 coated with the coat material 116 is inserted in the holder 112.

As the potting media 114, silicon rubber may be fitted, or rubber or resin with fluidity, glass or metal may be filled, followed by drying and curing at a low temperature so as not to cause the dropping-off of octadecylsilyl ligands, e.g., at about 200° C.

In the present embodiment, an uneven portion 116R is formed on the surface of the coat material 116. The inner circumferential face of the holder 112 is formed with a taper portion 112T.

The uneven portion 116R on the outer face of the coat material 116 may be formed by processing using sandpaper or by sandblasting, for example. The surface roughness thereof is at least 1 μm. For instance, when sandpaper is used, the uneven portion with roughness of 1 μm or larger can be formed by using sandpaper with roughness more than #600. When sandblasting is used, the surface roughness can be changed by changing the particle diameter of the sand to be sprayed.

Meanwhile, the taper portion 112T on the inner circumferential face of the holder 112 has a tapered shape with a diameter R2 at the outflow-side and a diameter R3 at the inflow-side along the overall length L1. The tapered shape of the taper portion 112T is narrowed along the flowing direction of the mobile phase. For example, the diameter R2 may be 3.2 mm and the diameter R3 may be 4.6 mm.

The potting media 114 is fitted or filled in the gap between the coat material 116 and the holder 112 while the uneven portion 116R is formed on the surface of the coat material 116, thus enhancing the binding force between the holder 112 and the potting media 114 and the biding force between the potting media 114 and the coat material 116. As a result, the monolithic rod 118 can be supported from the side face thereof, thus enhancing the pressure-tightness of the column. In order to enhance the binding force, the potting media 114 enters into the uneven portion 116R formed on the outer face of the coat material 116 so as to enhance the adhesion. Alternatively, the binding force may be enhanced by selecting materials mutually having good adhesion, or may be enhanced chemically by primer treatment, for example.

The taper portion 112T formed on the inner face of the holder 112 allows the force acting on the potting media 114 and the coated monolithic rod 118 from the mobile phase to be supported by such an inner face of the holder 112. Therefore, the holding force of the potting media 114 and the monolithic rod 118 against the pressure of the mobile phase can increase, thus enhancing the pressure tightness of the column.

The following describes the configuration of the upstream connection unit. The upstream connection unit includes a connection member 132, a fixed member 134, a filter 136, and a packing 138.

The connection member 132, the filter 136, and the packing 138 are placed between the fixed member 134 and the monolithic rod 118. A thread portion 134S is formed on the inner circumference of the fixed member 134 at an edge thereof, whereas a thread portion 112S is formed on the outer circumference of the holder 112 at an edge thereof. The thread portion 134S of the fixed member 134 is fastened with respect to the thread portion 112S of the holder 112, whereby the connection member 132, the filter 136, and the packing 138 are fixed and are brought into intimate contact with an end of the separation column unit by the fixed member 134.

An inflow-pipe (not illustrated) is connected with a connection unit 132C of the connection member 132, so as to let a sample and a mobile phase as a separation target flow into the separation column unit through an inlet 132I. The inflow sample and mobile phase pass through the filter 136 and diffuse in the radial direction, and then flow into the monolithic rod 118, in which they travel to the outflow side (downward in the drawing) while repeating desorption, whereby the sample is separated into each chemical component making up the same, which is then detected by the detector placed downstream of an outlet of the separation column.

The filter 136 used may be one obtained by hardening the powder of SUS, for example. Since the filter 136 includes minute gaps within it, a foreign substance with a diameter larger than these gaps can be removed. The filter 136 also functions as a diffusion member that lets the sample and the mobile phase diffuse in the radial direction via the above-stated gaps.

Similar to the upstream connection unit, the downstream connection unit includes a connection member 132′, a fixed member 134′, a filter 136′, and a packing 138′.

As described above, according to the present embodiment, the separation column can be manufactured at a temperature low enough to prevent the drop-off of octadecylsilyl ligands and the like during the manufacturing process thereof. Further, the binding force between the holder 112 and the potting media 114 and the binding force between the potting media 114 and the coat material 116 are enhanced, whereby the pressure tightness of the column can be enhanced. As a result, it is possible to provide a liquid chromatography system capable of performing the separation and analysis at a high speed, thus shortening the analysis time.

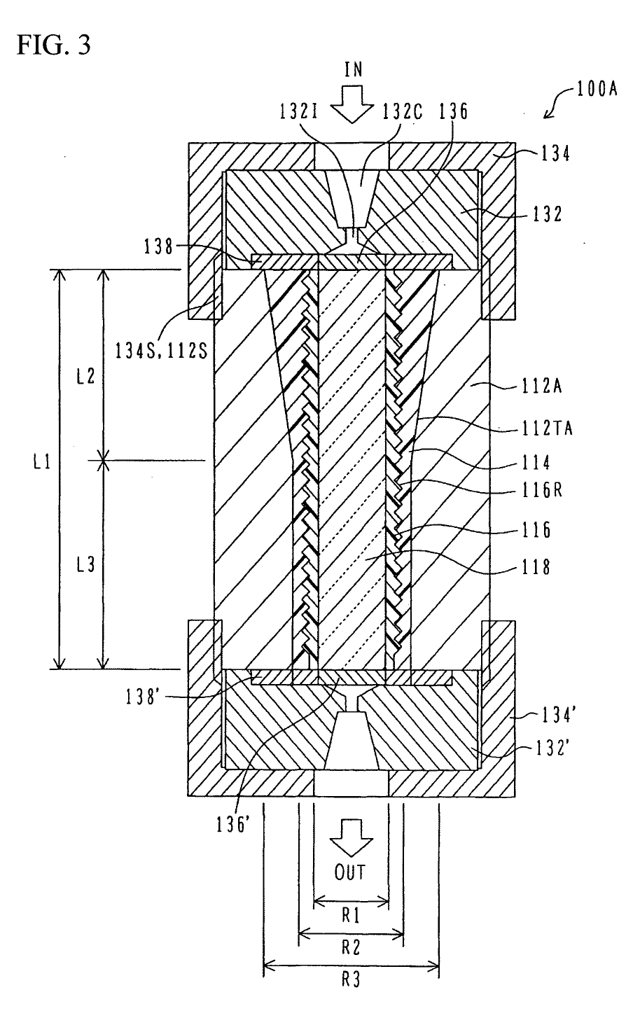

Referring now to FIG. 3, the configuration of a separation column according to Embodiment 2 of the present invention will be described below. Note here that the configuration of a liquid chromatography system to which the separation column of the present embodiment is applied is the same as in FIG. 1.

FIG. 3 is a cross-sectional view illustrating the configuration of the separation column according to Embodiment 2 of the present invention. Herein, the same reference numerals as those of FIG. 2 denote the same elements.

A feature of a separation column 100A of the present embodiment resides in the shape of a taper portion 112TA provided in the inner face of a holder 112A. The taper portion 112TA includes an upstream portion with a length L1 in a tapered shape and a downstream portion with a length L2 in a cylindrical shape. An uneven portion 116R on the outer face of a coat material 116 is the same as in the example of FIG. 2.

For instance, in the case where the separation column unit has a length L1 as long as 100 mm, if the holder 112 has a tapered shape along the overall length as in FIG. 2, the taper angle will be small, which means a shape closer to a cylinder. In such a case, there is a possibility that the inner face of the holder 112 cannot support sufficiently the force acting on the potting media 114 and the coated monolithic rod 118 from the mobile phase. To cope with this, the upstream portion may be a tapered shape, and the downstream side may be a cylindrical shape. The force suffered from the mobile phase is large in the upstream but decreases gradually along the axis line of the separation column unit. Therefore, the taper-shaped upstream portion allows the force acting on the potting media 114 and the coated monolithic rod 118 from the mobile phase to be supported sufficiently by the inner face of the holder 112A. Thus, the force supporting the potting media 114 and the monolithic rod 118 against the pressure of the mobile phase can increase, thus enhancing the pressure tightness of the column. For instance, in the case where the length L1 of the separation column unit is 100 mm, the length L2 of the taper portion may be 50 mm, and the length L3 of the cylindrical portion may be 50 mm.

According to the present embodiment also, the separation column can be manufactured at a temperature low enough to prevent the drop-off of octadecylsilyl ligands and the like during the manufacturing process thereof Further, the binding force between the holder 112A and the potting media 114 and the binding force between the potting media 114 and the coat material 116 are enhanced, whereby the pressure tightness of the column can be enhanced. As a result, it is possible to provide a liquid chromatography system capable of performing the separation and analysis at a high speed, thus shortening the analysis time.

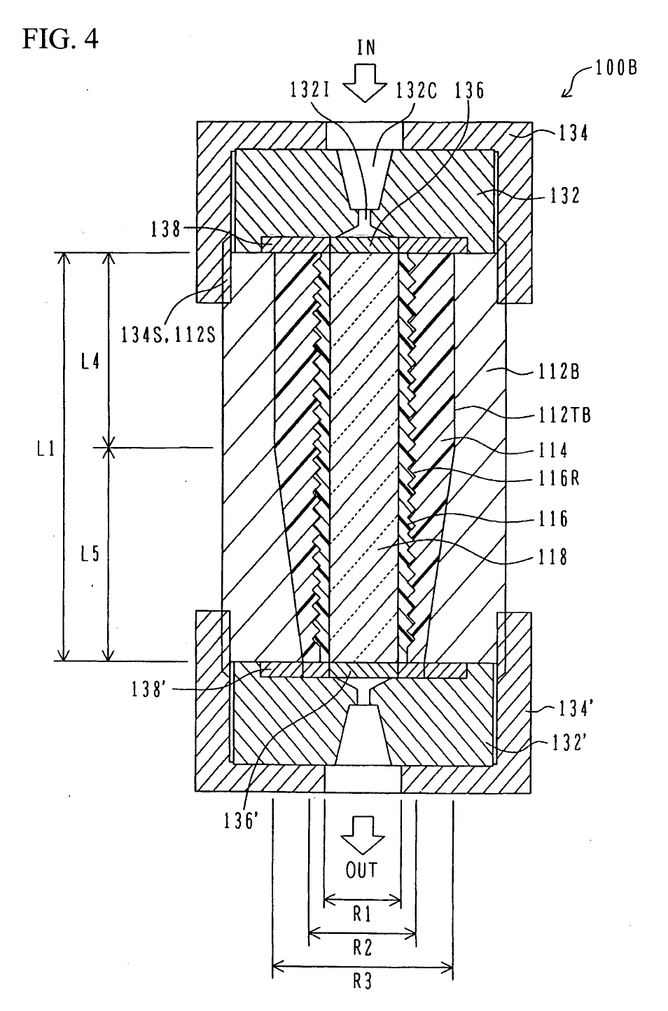

Referring now to FIG. 4, the configuration of a separation column according to Embodiment 3 of the present invention will be described below. Note here that the configuration of a liquid chromatography system to which the separation column of the present embodiment is applied is the same as in FIG. 1.

FIG. 4 is a cross-sectional view illustrating the configuration of the separation column according to Embodiment 3 of the present invention. Herein, the same reference numerals as those of FIG. 2 denote the same elements.

A feature of a separation column 100T of the present embodiment resides in the shape of a taper portion 112TB provided in the inner face of a holder 112T. The taper portion 112TB includes an upstream portion with a length L4 in a cylindrical shape and a downstream portion with a length L5 in a tapered shape. An uneven portion 116R on the outer face of a coat material 116 is the same as in the example of FIG. 2.

For instance, in the case where the separation column unit has a length L1 as long as 100 mm, if the holder 112 has a tapered shape along the overall length as in FIG. 2, the taper angle will be small, which means a shape closer to a cylinder. In such a case, there is a possibility that the inner face of the holder 112 cannot support sufficiently the force acting on the potting media 114 and the coated monolithic rod 118 from the mobile phase. To cope with this, even when the upstream portion is a cylindrical shape and the downstream portion is a tapered shape, the force acting on the potting media 114 and the coated monolithic rod 118 from the mobile phase can be sufficiently supported by the inner face of the holder 112A. Thus, the force supporting the potting media 114 and the monolithic rod 118 against the pressure of the mobile phase can increase, thus enhancing the pressure tightness of the column. For instance, in the case where the length L1 of the separation column unit is 100 mm, the length L4 of the cylindrical portion may be 50 mm, and the length L5 of the taper portion may be 50 mm.

According to the present embodiment also, the separation column can be manufactured at a temperature low enough to prevent the drop-off of octadecylsilyl ligands and the like during the manufacturing process thereof. Further, the binding force between the holder 112B and the potting media 114 and the binding force between the potting media 114 and the coat material 116 are enhanced, whereby the pressure tightness of the column can be enhanced. As a result, it is possible to provide a liquid chromatography system capable of performing the separation and analysis at a high speed, thus shortening the analysis time.

Various tapered shapes have been exemplified in the above description with reference to FIGS. 2 to 4. However, the tapered shape is not limited to a single-stage as in the above, but may be a multistage tapered shape. Further, the tapered angle may be changed continuously so that the tapered face may be a curved face.

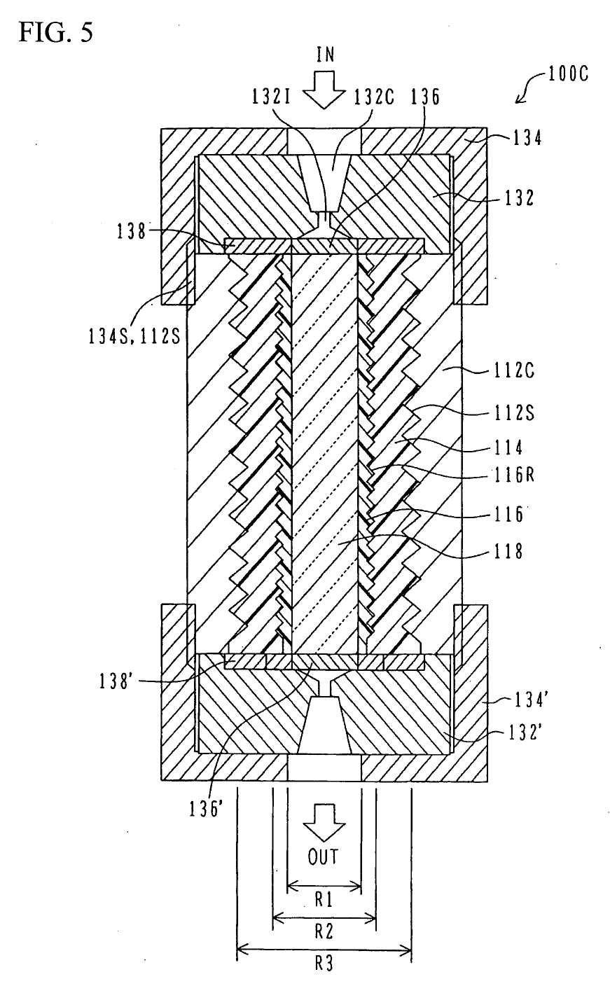

Referring now to FIG. 5, the configuration of a separation column according to Embodiment 4 of the present invention will be described below. Note here that the configuration of a liquid chromatography system to which the separation column of the present embodiment is applied is the same as in FIG. 1.

FIG. 5 is a cross-sectional view illustrating the configuration of the separation column according to Embodiment 4 of the present invention. Herein, the same reference numerals as those of FIG. 2 denote the same elements.

A feature of a separation column 100C of the present embodiment resides in the shape of the inner face of a holder 112C. The inner face of the holder 112C is formed with a thread portion 112S that is an uneven portion. The thread portion 112S is formed from an upstream end to a downstream end of the holder 112C. An uneven portion 116R on the outer face of a coat material 116 is the same as in the example of FIG. 2.

The thread portion 112S formed on the inner face of the holder 112C allows friction between the holder 112C and a potting media 114 to increase, which means the state of supporting the potting media 114 from the side face thereof by the holder 112C. Thus, the force supporting the potting media 114 and the coated monolithic rod 118 against the pressure of the mobile phase can increase, thus enhancing the pressure tightness of the column.

The type of the thread formed on the inner face of the holder 112C may be a triangular thread, a square thread, a trapezoidal thread, a sawtooth thread, a round thread, or the like. The thread is formed on the entire inner face of the holder, but may be formed at a part thereof.

The thread may be a helical groove or protrusion, and the shape of the helical groove or protrusion may be a triangle, a quadrangle, a trapezoid, an arc, or the like. The helical groove may be single-thread or multiple thread, and the pitch thereof may be uniform or nonuniform.

According to the present embodiment also, the separation column can be manufactured at a temperature low enough to prevent the drop-off of octadecylsilyl ligands and the like during the manufacturing process thereof. Further, the binding force between the holder 112C and the potting media 114 and the binding force between the potting media 114 and the coat material 116 are enhanced, whereby the pressure tightness of the column can be enhanced. As a result, it is possible to provide a liquid chromatography system capable of performing the separation and analysis at a high speed, thus shortening the analysis time.

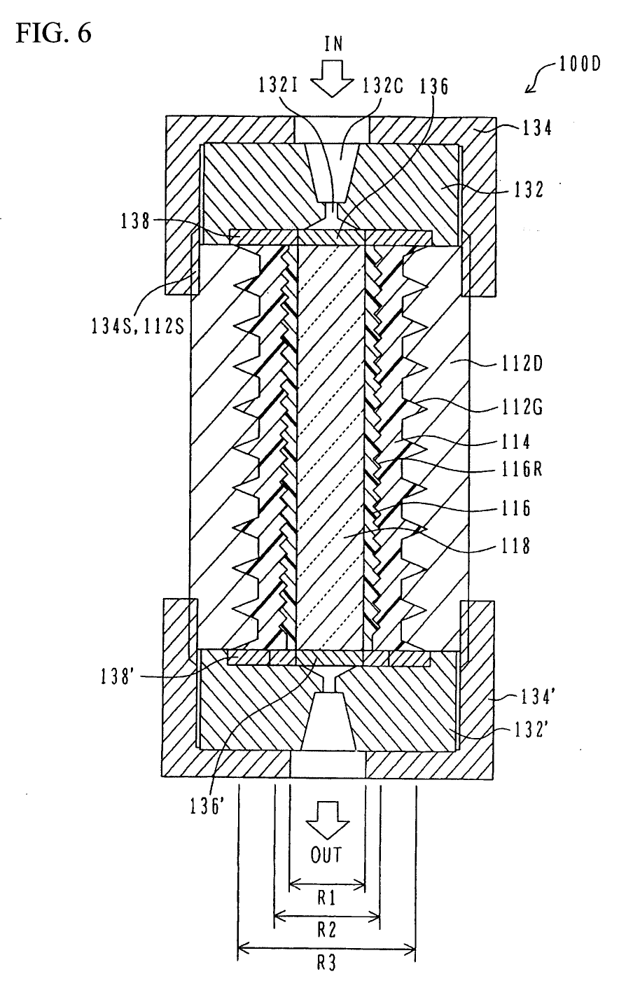

Referring now to FIG. 6, the configuration of a separation column according to Embodiment 5 of the present invention will be described below. Note here that the configuration of a liquid chromatography system to which the separation column of the present embodiment is applied is the same as in FIG. 1.

FIG. 6 is a cross-sectional view illustrating the configuration of the separation column according to Embodiment 5 of the present invention. Herein, the same reference numerals as those of FIG. 2 denote the same elements.

A feature of a separation column 100D of the present embodiment resides in the shape of the inner face of a holder 112D. The inner face of the holder 112D is formed with a groove portion 112G that is an uneven portion. The groove portion 112G is formed from an upstream end to a downstream end of the holder 112D. The groove portion 112G includes a large number of grooves each having a depth of about 0.5 mm around the circumference, and the groove is orthogonal to the axis direction. The groove may be formed not on the entire inner face of the holder but at a part thereof An uneven portion 116R on the outer face of a coat material 116 is the same as in the example of FIG. 2.

The groove portion 112G formed on the inner face of the holder 112D allows friction between the holder 112D and a potting media 114 to increase, which means the state of supporting the potting media 114 from the side face thereof by the holder 112D. Thus, the force supporting the potting media 114 and the coated monolithic rod 118 against the pressure of the mobile phase can increase, thus enhancing the pressure tightness of the column.

The groove may be oblique with reference to the axis direction, or a plurality of grooves may intersect like a mesh. The shape of the groove may be a triangle, a quadrangle, an arc, an oval, or the like. The interval of the grooves may be uniform or nonuniform. The same goes for the protrusion.

Instead of the groove, a protrusion may be formed on the holder, or both of the groove and the protrusion may be formed.

According to the present embodiment also, the separation column can be manufactured at a temperature low enough to prevent the drop-off of octadecylsilyl ligands and the like during the manufacturing process thereof Further, the binding force between the holder 112D and the potting media 114 and the binding force between the potting media 114 and the coat material 116 are enhanced, whereby the pressure tightness of the column can be enhanced. As a result, it is possible to provide a liquid chromatography system capable of performing the separation and analysis at a high speed, thus shortening the analysis time.

What is claimed is:

1. A separation column including a cylindrical monolithic rod made of a porous body, the separation column separating a sample and a mobile phase flowing into the monolithic rod and comprising:
a coat material coating an outer circumference of the monolithic rod and including an uneven portion on an outer face thereof;
a holder into which the monolithic rod coated with the coat material is inserted, the holder including a narrow portion or an uneven portion on at least a part of an inner face thereof along an inflow direction; and
a potting media fitted or filled between the coat material and the holder.

2. The separation column according to claim 1,
wherein the uneven portion on the face of the coat material is formed by sandpaper or by sandblasting.

3. The separation column according to claim 1,
wherein the coat material comprises a heat shrinkable tube or resin coating,
the potting media comprises silicon rubber or an adhesive, and
the holder comprises metal or resin.

4. The separation column according to claim 1,
wherein the uneven portion on the inner face of the holder comprises a thread portion or a groove portion.

5. The separation column according to claim 1,
wherein the narrow portion on the inner face of the holder has a tapered shape.

6. A liquid chromatography system including a pump sucking a mobile phase; an autosampler sucking a sample; a separation column held in a thermo-controlled bath, into which the mobile phase sucked by the pump and the sample sucked by the autosampler are supplied to be separated into a respective component; and a detector detecting the respective component separated by the separation column,
wherein the separation column includes a cylindrical monolithic rod made of a porous body and separating a sample and a mobile phase flowing into the monolithic rod, the separation column comprising:
a coat material coating an outer circumference of the monolithic rod and including an uneven portion on an outer face thereof,
a holder into which the monolithic rod coated with the coat material is inserted, the holder including a narrow portion or an uneven portion on at least a part of an inner face thereof along an inflow direction; and
a potting media fitted or filled between the coat material and the holder.
